(19) United States
(12) Patent Application Publication
(10) Pub. No.: US 2026/0054407 A1
(43) Pub. Date: Feb. 26, 2026

(54) FOOD PRODUCT SLICER WITH REMOVABLE MEAT GRIP ASSEMBLY SLIDE ROD

(71) Applicant: ILLINOIS TOOL WORKS INC., Glenview, IL (US)

(72) Inventors: Matthew W. BIRD, Xenia, OH (US); Sumuk MANJUNAATH, Dayton, OH (US)

(21) Appl. No.: 19/299,480

(22) Filed: Aug. 14, 2025

Related U.S. Application Data
(60) Provisional application No. 63/684,932, filed on Aug. 20, 2024.

(51) Int. Cl. B26D 7/01; B26D 7/06

(52) U.S. Cl. CPC B26D 7/01; B26D 7/0616; B26D 2210/02

(57) ABSTRACT

A food product slicer includes a base, a knife mounted for rotation relative to the base, a carriage assembly mounted to the base for reciprocal movement back and forth past a cutting edge of the knife, wherein the carriage includes a tray, a movable gauge plate for varying a thickness of food product slices, a slide rod releasably connected to the tray and having a slide rod axis and a meat grip assembly mounted on the slide rod. The slide rod is releasably retained to the tray by a seating arrangement, and the slide rod is biased outwardly along the slide rod axis away from the knife, and/or a mount arrangement of the slide rod includes a keyway style opening with slide rod retaining features.

### TECHNICAL FIELD

This application relates generally to food product slicers of the type commonly used to slice bulk food products and, more specifically, to a mount arrangement of a meat grip assembly in such a food product slicer.

### BACKGROUND

Typical reciprocating food slicers have a rotatable, circular or disc-like slicing blade, an adjustable gauge plate for determining the thickness of the slice and a carriage for supporting the food as it is moved back and forth past the cutting edge of the knife during slicing. A drive motor may be linked to drive the carriage back and forth during an automatic slicing operation carried out by a controller of the slicer. The gauge plate is situated along the edge of the knife toward the front of a slicing stroke and is laterally movable with respect to the knife edge plane for determining the thickness of the slices to be cut. A rotatable adjustment or indexing knob is provided for manually setting a spacing between the plane of the gauge plate surface and the plane of the knife edge for the purpose of slicing so that operators can select a thickness of slices to be produced.

Typical slicers either have a threaded rod or permanently attached meat grip assembly slide rod (attached to the carriage). The slicers that permanently attach the slide rod generally remove a smaller portion of the meat grip to satisfy cleanability requirements.

U.S. Patent Publication No. 2012/0266731 describes a removable slide rod. In two embodiments, a spring-biased pin is biased into engagement with the slide rod in a direction transverse to the slide rod axis to releasably retain the slide rod in place. In a third embodiment a flexing retention clip is used to releasably hold the slide rod in place. In a fourth embodiment, the slide rod is threadedly attached. These embodiments add complexity and cost to the manufacturing process and/or create some difficulty with slide rod removal and installation.

Accordingly, it would be desirable to provide a slicer with an improved meat grip assembly slid rod mounting system that is simpler and more ergonomic in terms of slide rod removal and installation.

### SUMMARY

In one aspect, a food product slicer includes a base, a knife mounted for rotation relative to the base, a carriage assembly mounted to the base for reciprocal movement back and forth past a cutting edge of the knife, wherein the carriage includes a tray, a movable gauge plate for varying a thickness of food product slices, a slide rod releasably connected to the tray and having a slide rod axis and a meat grip assembly mounted on the slide rod. The slide rod is releasably retained to the tray by a seating arrangement, and the slide rod is biased in a direction 53 outwardly along the slide rod axis away from the knife.

In another aspect, a food product slicer includes a base, a knife mounted for rotation relative to the base, a carriage assembly mounted to the base for reciprocal movement back and forth past a cutting edge of the knife, wherein the carriage includes a tray, a movable gauge plate for varying a thickness of food product slices, a slide rod releasably connected to the tray and having a slide rod axis and a retention lug, and a meat grip assembly mounted on the slide rod. The tray includes a mount bracket having an opening through which the slide rod extends. The opening is of non-circular shape that is defined at least in part by a retention ledge, wherein, in a first rotational position of the slide rod, the retention lug is offset from the retention ledge so as to be movable into and out of the opening, wherein, in a second rotational position of the slide rod, the retention lug aligns with the retention ledge such that, when the retention lug is positioned inwardly of the retention ledge, the retention lug cooperates with the retention ledge to prevent axially outward movement of the slide rod.

In a further aspect, a food product slicer includes a base, a knife mounted for rotation relative to the base, a carriage assembly mounted to the base for reciprocal movement back and forth past a cutting edge of the knife, wherein the carriage includes a tray, a movable gauge plate for varying a thickness of food product slices, a slide rod releasably connected to the tray and having a slide rod axis and a meat grip assembly mounted on the slide rod. A mount arrangement of the slide rod includes a keyway style opening with slide rod retaining features.

### BRIEF DESCRIPTION OF DRAWINGS

FIGS. 1 and 2 show perspective views of a food product slicer;

FIGS. 3-5 show perspective views or a carriage assembly of the slicer;

FIGS. 6-11 show the carriage and meat grip assembly, or portions thereof;

FIGS. 12A-12B show a relative orientation between the slide rod and mount bracket that enables slide rod removal;

FIGS. 13A-13B show a relative orientation between the slide rod and mount bracket that enables slide rod retention in its use position;

FIG. 14 shows a perspective cross-section of the slide rod retention lug engaged in its retaining position; and

FIGS. 15-16 show cross-sections of the inward distal end of the slide rod engages with a biasing member.

### DETAILED DESCRIPTION

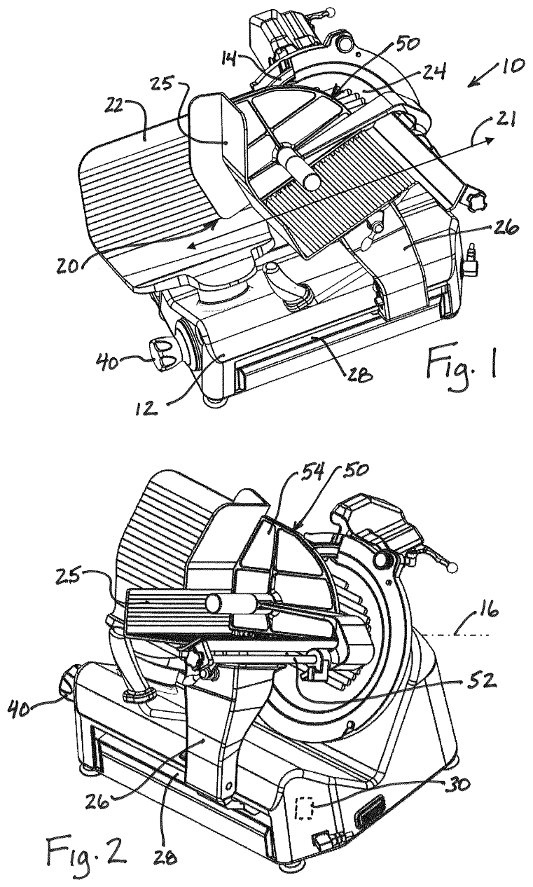

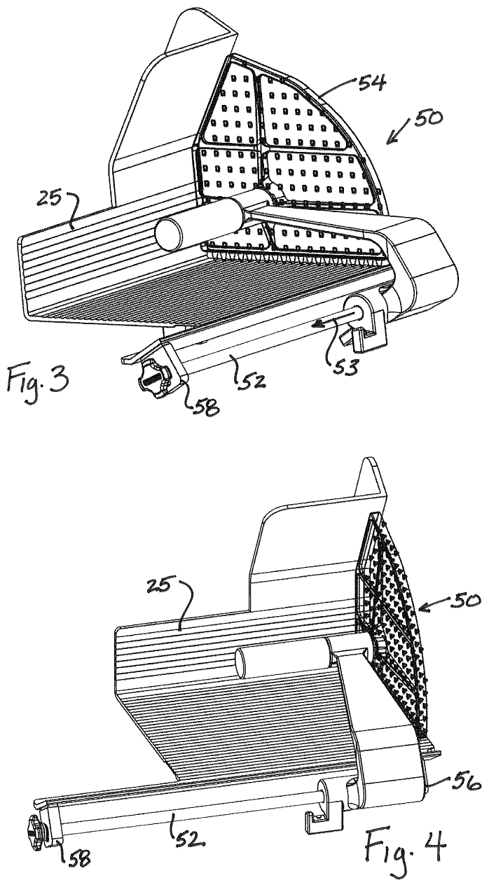

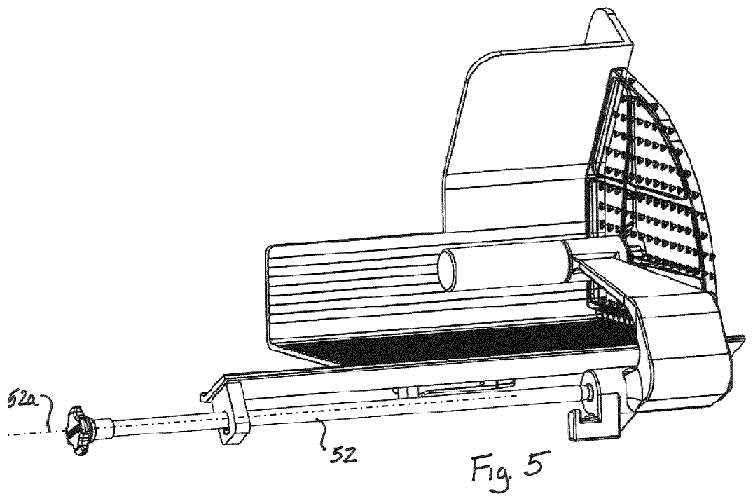

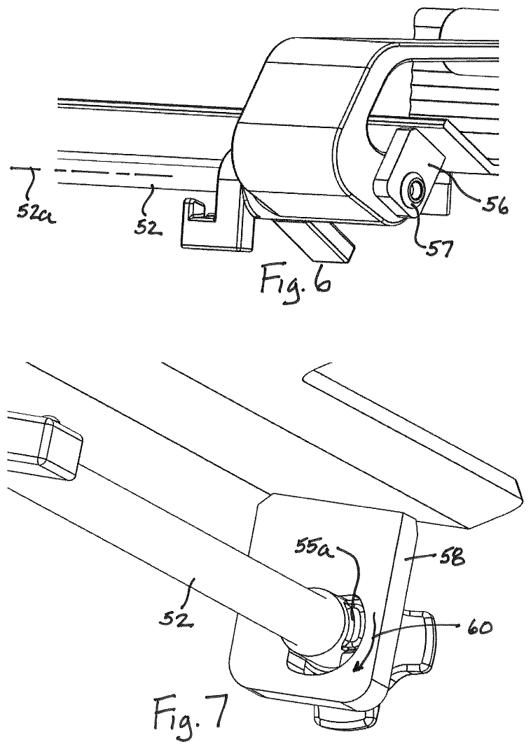

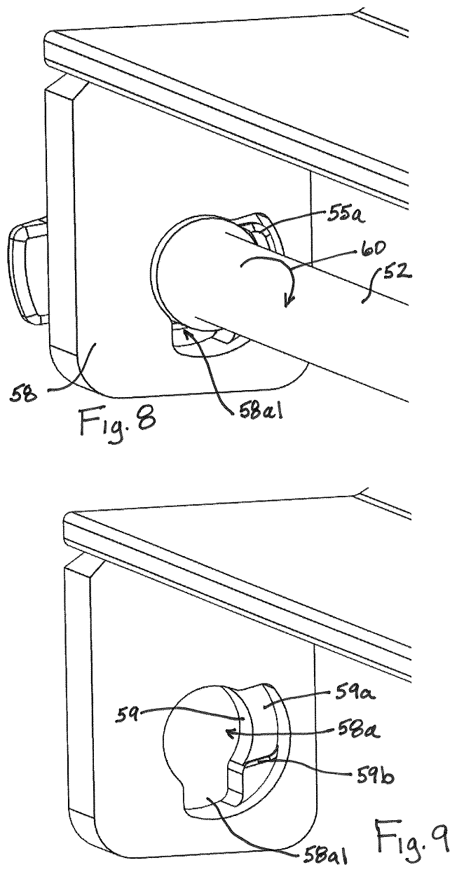

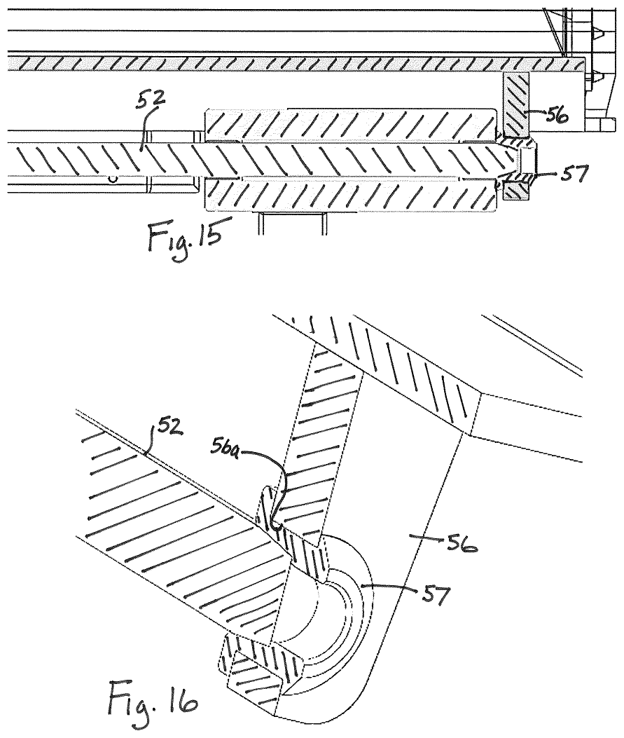

Referring to FIGS. 1-16, a food product slicer 10 includes a housing or base 12 and a circular, motor-driven slicing knife 14 that is mounted to the housing for rotation about an axis 16. The left side of FIG. 1, where the controls (e.g., adjustment knob) are located, is generally referred to as the front side of the slicer (which is where an operator stands for slicing), the right side of FIG. 1 is generally referred to as the rear side of the slicer. A food product can be supported on a manually operable (or motor driven) food carriage 20 which moves the food product to be sliced past the cutting edge 14a of the rotating slicing knife 14. The food carriage 20 reciprocates from left to right relative to FIG. 1, along a linear path 21 so that the lower end of the bulk food product slides along the surface of a gauge plate 22, is cut by the knife 14 and then slides along a knife cover plate 24. Food carriage 20 includes a tray 25 mounted on a tray arm 26 that orients the food carriage tray at the appropriate angle (typically perpendicular) to the knife cutting-edge plane. The food carriage arm reciprocates along a slot 28 at a lower portion of the housing 12. The carriage 20 can be moved manually (e.g., by a handle) and/or the carriage 20 may also be automatically driven (e.g., as by an internal motor 30 that drives a belt that is linked internally to a transport to which the arm 26 is pivotably connected). A gauge plate adjustment system includes a rotatable knob 40 (connected to an opening in the base 12) linked such that rotation of the knob 40 shifts the location of surface 22 relative to the knife edge cutting plane.

A meat grip assembly 50 is mounted on a slide rod 52 and can move axially along and pivotably about the slide rod 52 to handle different lengths of food product sitting on the tray 25. Generally, a pusher plate 54 of the meat grip assembly sits against the outwardly facing end (the end furthers from the knife cutting plane) of the food product chub to apply some force against the food product to urge the food product down along the tray surface toward the gauge plate 22. The slide rod 52 is mounted to the tray 25 by a mount bracket 56 connected to the tray and a mount bracket 58 connected to the tray, with mount bracket 58 located axially outward of and spaced away from mount bracket 56. The mount bracket 58 includes a through opening 58a through which the slide rod 52 extends. The distal end of the slide rod 52 engages into a hole 56a of the mount bracket 56. A resilient member 57, such as a rubber stopper or gasket, is engaged in the hole 56a such that, when the slide rod is in its use position, the resilient member exerts a forces on the slide rod that biases the slide rod outwardly along a slide rod axis 52a.

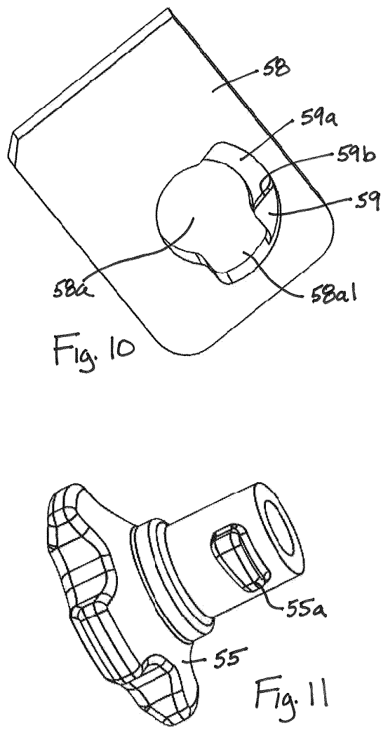

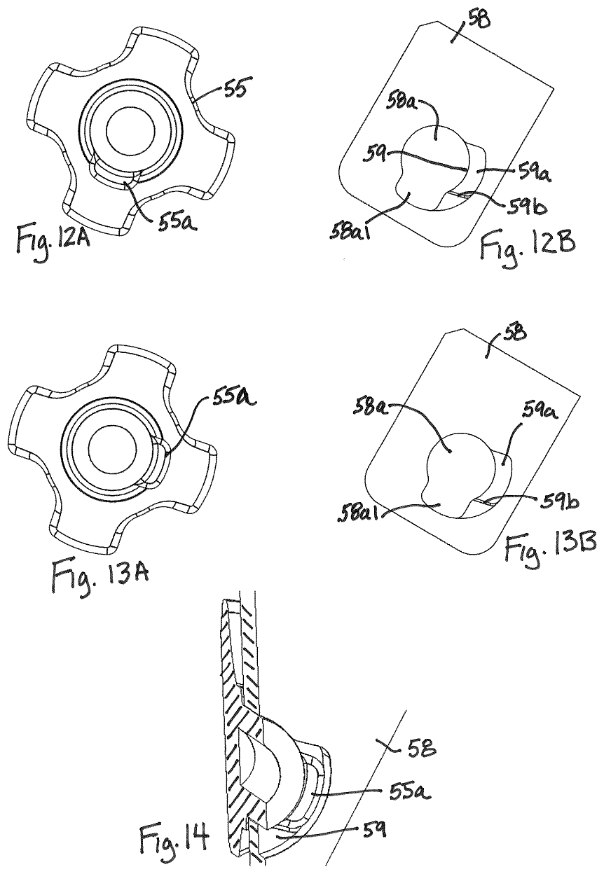

The opening 58a of bracket 58 is non-circular and defined in part by a retaining ledge 59. The slide rod 52 includes a grippable end knob 55 that includes a radially outwardly extending retention lug 55a. In a first rotational position of the slide rod, the retention lug 55a is rotational offset from the retention ledge 59 so as to be movable into and out of the opening (e.g., retention lug is passable through region 58a1 of the opening). In a second rotational position of the slide rod, the retention lug 55a aligns with the retention ledge 59 such that, when the retention ledge is positioned inwardly of the retention ledge toward the knife cutting plane, the retention lug 55a cooperates with the retention ledge to prevent axially outward movement of the slide rod 52. Here, the first rotational position (represented by the relative positions in FIGS. 12A-12B) is offset from the second rotational position (represented by the relative positions in FIGS. 13A-13B) by no more than one-hundred twenty degrees (e.g., such as by no more than one-hundred ten degrees or no more than one-hundred degrees, such as between ninety and one-hundred degrees). This facilitates ease of operator manipulation of the slide rod between a mounted position (retention lug 55a behind the retention ledge 59) and a removal/install position (retention lug 55a aligned with region 58a1) that allows install and removal of the slide rod (e.g., with only a one-hundred twenty degree or less manual rotation of the slide rod required). Thus, in embodiments, the shape of opening 58 and the shape of the knob and lug effectively form a keyway type connection.

The retention ledge 59 includes an outwardly recessed portion 59a into which the retention lug 55a seats such that a stepped part 59b of the retention ledge resists rotation of the slide rod in a direction 60 that would move the retention lug 55a out of alignment with the retention ledge and into the region 58a1. However, with sufficient rotational force applied to the greppable knob 55, the slide will be force slightly axially inward (out of the recess 59a) to allow the retention lug 55a to rotate into alignment with region 58a1. The shape of the opening 58a is also such that, when the retention lug 55a is disposed in the opening 58 and beyond the retention ledge 59, rotation of the slide rod 52 is limited to back and forth rotation between the first and second positions.

The above attachment system provides one or mor advantages such as being (i) simple and easy to use - this slide rod attachment method should make cleaning and slicer breakdown easier and quicker and/or (ii) easy-to-remove, which should make operators more willing to remove and properly clean/sanitize these parts and/or (iii) operating as a quick-release for the slide rod.

It is to be clearly understood that the above description is intended by way of illustration and example only and is not intended to be taken by way of limitation. Variations are possible.

1. A food product slicer, comprising:
a base;
a knife mounted for rotation relative to the base;
a carriage assembly mounted to the base for reciprocal movement back and forth past a cutting edge of the knife, wherein the carriage includes a tray;
a movable gauge plate for varying a thickness of food product slices;
a slide rod releasably connected to the tray and having a slide rod axis;
a meat grip assembly mounted on the slide rod;
wherein the slide rod is releasably retained to the tray by a seating arrangement, and the slide rod is biased outwardly along the slide rod axis away from the knife.

2. The food product slicer of claim 1, wherein the tray includes a first mount bracket into which a distal end part of the slide rod engages, wherein a biasing member is engaged in the mount bracket and urges the slide rod outwardly along the slide rod axis.

3. The food product slicer of claim 2, wherein the biasing member comprises a resilient component engaged in a first opening of the first mount bracket.

4. The food product slicer of claim 2, wherein the seating arrangement includes a second mount bracket spaced axially outward and away from the first mount bracket, the second mount bracket including a retention ledge, and the slide rod includes a retention lug that is selectively alignable for seating against the retention ledge.

5. The food product slicer of claim 4, wherein the second mount bracket includes a second opening of non-circular shape that is defined at least in part by the retention ledge, wherein, in a first rotational position of the slide rod, the retention lug is offset from the retention ledge so as to be movable into and out of the second opening, wherein, in a second rotational position of the slide rod, the retention lug aligns with the retention ledge such that, when the retention ledge is positioned inwardly of the retention ledge, the retention lug is biased into engagement with the retention ledge.

6. The food product slicer of claim 5, wherein the retention ledge includes an outwardly recessed portion into which the retention lug seats such that a part of the retention ledge resists rotation of the slide rod in a direction that would move the retention lug out of alignment with the retention ledge.

7. The food product slicer of claim 5, wherein the first rotational position is offset from the second rotational position by no more than one-hundred twenty degrees.

8. The food product slicer of claim 4, wherein the slide rod includes an end knob and the retention lug is part of the end knob.

9. A food product slicer, comprising:
a base;
a knife mounted for rotation relative to the base;
a carriage assembly mounted to the base for reciprocal movement back and forth past a cutting edge of the knife, wherein the carriage includes a tray;
a movable gauge plate for varying a thickness of food product slices;
a slide rod releasably connected to the tray and having a slide rod axis and a retention lug;
a meat grip assembly mounted on the slide rod;
wherein the tray includes a mount bracket having an opening through which the slide rod extends, the opening being of non-circular shape that is defined at least in part by a retention ledge, wherein, in a first rotational position of the slide rod, the retention lug is offset from the retention ledge so as to be movable into and out of the opening, wherein, in a second rotational position of the slide rod, the retention lug aligns with the retention ledge such that, when the retention lug is positioned inwardly of the retention ledge, the retention lug cooperates with the retention ledge to prevent axially outward movement of the slide rod.

10. The food product slicer of claim 9, wherein the slide rod is biased outwardly along the slide rod axis to urge the retention lug into engagement with the retention ledge.

11. The food product slicer of claim 10, wherein a distal end part of the slide rod engages a biasing member that urges the slide rod outwardly along the slide rod axis.

12. The food product slicer of claim 10, wherein the retention ledge includes an outwardly recessed portion into which the retention lug seats such that a part of the retention ledge resists rotation of the slide rod in a direction that would move the retention lug out of alignment with the retention ledge.

13. The food product slicer of claim 9, wherein the first rotational position is offset from the second rotational position by no more than one-hundred twenty degrees.

14. A food product slicer, comprising:
a base;
a knife mounted for rotation relative to the base;
a carriage assembly mounted to the base for reciprocal movement back and forth past a cutting edge of the knife, wherein the carriage includes a tray;
a movable gauge plate for varying a thickness of food product slices;
a slide rod releasably connected to the tray and having a slide rod axis and a retention lug;
a meat grip assembly mounted on the slide rod;
a mount arrangement of the slide rod includes a keyway opening with slide rod retaining features.

15. The food product slicer of claim 14, wherein the keyway opening is formed in a mount bracket of the carriage assembly and the slide rod includes a portion with a shape corresponding to the keyway opening.

16. The food product slicer of claim 14, wherein the keyway opening is defined at least in part by a retention ledge with outwardly recessed portion into which a retention lug of the slide rod is seatable.
